(19) United States
(12) Patent Application Publication
(10) Pub. No.: US 2023/0141453 A1
(43) Pub. Date: May 11, 2023

(54) A METHOD AND AN APPARATUS FOR REDUCTION OF HARSHNESS OF SPIRIT USING PHYSICOCHEMICAL CONDITIONS

(71) Applicant: UNITED SPIRTS LIMITED, Bangalore (IN)

(72) Inventors: Dilip Kumar SENGUPTA, Kolkata (IN); Narendra RAUT, Navi-Mumbai (IN)

(21) Appl. No.: 17/918,589

(22) PCT Filed: Apr. 12, 2021
(86) PCT No.: PCT/IB2021/052991

§ 371 Date: Oct. 13, 2022

(30) Foreign Application Priority Data
Apr. 13, 2020 (IN) 202041015887

(51) Int. Cl. C12H 1/12; C12G 3/00

(52) U.S. Cl. CPC C12H 1/12; C12G 3/00

(57) ABSTRACT

A method and corresponding apparatus for reduction of harshness from a fresh spirit, by controlling physico-chemical conditions. The method requires operation at a specific temperature, pressure and for required time to achieve desirable improvements n taste. To perform the method, spirit is filled into a reaction vessel, where oxygen-containing gas is introduced to maintain a pressure in a range between 0.3 to 2.0 kg/cm². The spirit is heated slowly with continuous stirring to elevate the temperature to between 30° C. and 50° C. The same gas pressure and temperature are maintained for an extended period, e.g. one to four weeks. Analysis showed reduction in harshness and improvement in sensory attributes without affecting the levels of esters, acids and aldehydes except acetaldehyde.

### DESCRIPTION OF THE INVENTION

### Technical Field of the Invention

The present invention relates to a method and an apparatus for reduction of harshness in taste of a fresh spirit, by controlling physico-chemical conditions. The invention also relates to a method of reducing harshness and improvement of sensorial attributes such as sweet, fruity, floral and mellow notes in the fresh spirit by control of specific physical parameters such as temperature, pressure by oxygen gas and time. The invention is particularly useful for achieving accelerated ageing (i.e. as associated with improved taste) of the spirit prior to human consumption.

### BACKGROUND OF THE INVENTION

Freshly distilled spirit contains desirable congeners such as acids, aldehydes, furfural, esters, higher alcohols etc., but also various undesirable sulphur compounds such as thiophene, 2-methyl thiophene, 2, 5 Dimethyl thiophene, S-methyl thioacetate, dimethyl trisulphide, dimethyl disulphide etc. [J. R. Piggott, Flavour of Distilled Beverages, Origin and Development, 1983, Ellis Horwood Limited]. There is also the presence of acetic acid, which contributes to harsh and pungent notes in a malt spirit. Acetic acid is pungent but required during maturation for ester formation. However, the sulphur compounds are not desirable as they impart harshness to the fresh spirit and need to be removed.

The quality of fresh spirit is affected by the presence of undesirable harshness and the maturation or aging of the spirit is a complex phenomenon with various chemical reactions occurring simultaneously. The maturation or aging of a fresh spirit is achieved by storing distilled spirits in barrels or wooden casks for a specific period of time. The goal of maturation or aging is to remove harsh flavors from the fresh spirit, while adding distinct flavor characteristics found in the barrel's wood. The process typically requires several months to years to achieve removal of harshness and to improve sensory attributes.

In warm climatic conditions (e.g. as found in tropical countries), during the process of removal of harshness while maturation, the cask releases high levels of wood extractives along with astringency. This can overpower the distillery congeners, thereby developing a very complex spirit, which may be taste challenging. Also, the lifetime of the wooden cask is reduced drastically due to the higher wood extraction during each cycle of maturation. Accordingly, reduced ageing time in casks in warm climatic conditions is preferred, in order to have the right amount of wood extractives, while retaining properties of distillery congeners. However, while doing so, the harsh taste of the fresh spirit can be perceived in the matured spirit.

As stated, the aging process of fresh spirit occurs through complex chemical reactions, which are broadly classified into additive reactions, subtractive reactions and interactive reactions. In additive reactions, the wood components are leached into the spirit, thereby providing desired woody notes. In the interactive reactions, desired fruity notes are developed by slow esterification of ethyl alcohol and fuel oils with acetic acid and higher fatty acids. More importantly, in case of subtractive reactions, undesirable sulphur compounds such as thiophene, 2-methyl thiophene, 2, 5 dimethyl thiophene, S-methyl thioacetate, dimethyl trisulphide, dimethyl disulphide etc., which are responsible for harshness in fresh spirits, either get trapped in the cask wood or are lost through its pores during maturation of the spirit [Clyne et al, International Journal of Food Science and Technology, Vol 28, pp 69-81]. However, this is a very slow process and it is necessary to accelerate it by rapid elimination of undesirable sulphur compounds to reduce the harshness of the fresh spirit faster.

The aging process involves significant cost and time in order to obtain a quality spirit. Further, the process lengthens the production cycle to years and severely limits the production capacity.

Various methods related to the reduction of harshness during the aging process of a spirit have been proposed.

Chinese Patent Application CN201410382654 discloses an aging method of a distilled spirit. The method comprises storage of wine liquid followed by steam introduction and control of the temperature. According to the method, the wine storage temperature is controlled by introducing wine steam, whereby physical reaction and chemical reaction of a wine is accelerated. Ageing of the wine is promoted, while storage time is greatly reduced, and the foreign flavor, mud flavor, distilled grain flavor and bitter taste of wine liquid are also removed to ensure that a wine body is soft, pure and harmonious in taste. The invention discloses the adjustment of temperature but not other physical parameters.

Chinese Patent Application CN95221595 relates to a device for ageing white spirit by simultaneously adopting a chemical method and a physical method, comprising an ultrasonic white spirit ageing machine, a releaser hang basket for a chemical ageing accelerator and a releaser for chemical ageing accelerator which are arranged on the cylinder wall of an ageing cylinder of the ultrasonic white spirit ageing machine. The aging process of white spirit is accelerated by treating with ultrasound in the ageing cylinder, so that the quality and taste of white spirit is improved. The invention discloses a direct treatment of ultrasound, but not any other physical parameters.

US patent application U.S. Ser. No. 10/196,595B2 discloses devices and method that enable controlled, repeatable and accelerated ageing and infusion of alcohol containing beverages. The device comprises reaction canisters in a computer-controlled environment of valves, pumps, interconnecting plumbing, sensors, mixing and dispersing manifolds. The infusing materials include traditional ageing or infusing materials such as oaks traditionally used to make barrels for ageing and infusion as well as other woods and a variety of non-wood infusion materials such as citrus, beans and seeds. The combination of controls, sensors and computer interface allows for repeatable preparation of aged or infused drinks and for development of new aged or infused drinks.

US Patent Application U.S. Pat. No. 6,344,226B1 discloses a method of maturation of spirit by adding a food grade solvent such as ethyl acetate to the oak aged alcoholic product and mixing the two liquids. The resulting mixture is allowed to separate into two layers: a first layer and a second layer. The first layer, including the food grade solvent, flavors, color, alcohol (i.e., ethanol) and water, is separated from the second layer. The solvent is then removed from the first layer to produce an extract. The extract can be added to a less costly alcoholic beverage, such as grain neutral spirits (GNS) or sugar beet spirits to produce a beverage having the taste of a mature oak aged alcoholic beverage. The application also discloses an accelerated whisky maturation method, including combining an alcoholic distillate with toasted oak chips, heating and aerating and oxygenating the resulting mixture to produce an accelerated oak aged alcoholic product. The toasted oak chips are then removed.

US Patent Application US20180057780A1 discloses a system and method for accelerating the aging process of spirits. The application discloses two types of aging methods: soaking selected wood fibers or chips with spirits in situ in presence of carbon dioxide; and processing selected wood fibers or chips in carbon dioxide to obtain activated wood fibers or chips, that are then soaked with spirits. The application also discloses a system for spirit aging, which comprises a carbon dioxide supply device with a pump and a filter, a carbon dioxide performance vessel with a temperature and pressure control element, a mesh cage device for holding wood fibers or chips and a carbon dioxide separation and recycle device. Wood and activated wood are further impregnated with natural flavors, vitamins, minerals, antioxidants and therapeutics in a carbon dioxide environment. The activated wood or impregnated wood is then combined with spirit and soaked in ambient, vacuum, pressure or carbon dioxide environment to obtain an aged and flavor enriched spirit.

According to the known art, it has been observed that no efforts have been made to reduce the harshness taste of spirit by use of physico-chemical methods having the right combination of temperature and pressure in oxygen environment. To the Knowledge of the present inventors, the existing methods do not disclose the details of selective removal of sulphur impurities from a spirit that leads to a harshness taste.

Accordingly, there is an identified need for removal of harshness from a spirit associated with maturation in a wooden cask.

### SUMMARY OF THE INVENTION

The invention relates to a method for reduction of harshness from spirit according to claim 1, by controlling physico-chemical conditions. In one form the method is embodied by an apparatus according to claim 15, that comprises a reaction vessel, a hot plate or similar heating means, a stirrer, a means of temperature control and means of introducing an oxygen-containing gas. The apparatus may include measurement sensor(s)/probe(s), an airtight lid, a temperature display, a pressure gauge, an oxygen gas regulator, and an oxygen gas cylinder.

The invention particularly discloses a simple and selective method for reduction of harsh taste from a spirit. The method achieves an improvement of sensorial attributes such as sweet, fruity, floral and mellow notes in the spirit by control of specific temperature, pressure and time.

Particularly, the method achieves a selective reduction of sulphur compounds while leaving other important flavour chemicals in the spirit. This in turn helps to reduce the harshness of the spirit and unmask the required key attributes such as fruity, floral, sweetness etc. in the fresh spirit.

The harshness of the spirit is mitigated/removed by eliminating the sulphur compounds using oxidative reactions and by using physico-chemical parameters such as temperature, oxygen gas pressure and time.

The method for reduction of harshness is achieved using a reaction vessel. The physical parameters of the reaction vessel are maintained at temperature and pressure according to the invention. After adding distilled spirit (e.g. fresh malt spirit), oxygen gas is introduced into the reaction vessel to maintain pressure, e.g. in a range between 0.3 to 2.0 kg/cm2 (30-200 kPa), e.g. by bubbling through the liquid. The spirit is heated slowly with continuous stirring to elevate the temperature to within a range of approximately 30° C. to 50° C. and the same oxygen gas pressure and temperature is maintained for, e.g., a period of 1 to 4 weeks. The precise physicochemical conditions, such as the temperature of reaction, pressure of oxygen gas and time of reaction, depends on the quality of fresh spirit from harshness standpoint. In one example, the best results are obtained at a temperature of 38° C., oxygen pressure of 0.5 kg/cm2 and a duration of two weeks. After two weeks, the spirit can be sensorially analyzed for harshness and sensory attributes and compared with untreated fresh spirit. Exposure to the above reaction significantly reduces sulphur compounds responsible for harsh notes. However, over-oxidation of ethyl alcohol can lead to acetaldehyde and acetal formation in the spirit, resulting in an oxidative sensory note. Hence, an optimum time of exposure is an important consideration.

In one form of the method the oxygen-containing gas is pure (or substantially pure) oxygen. However, lower concentrations of oxygen in a gas mixture, such as air (at about 21% oxygen), can achieve the effects of the invention, albeit with a lower rate of reaction, requiring a longer period. A preferred form of the invention requires an oxygen concentration of 40-100%.

The method of the invention may result in reduction of the perceived harshness of the spirit by 67% i.e. from 6 to 2 and reduction in freshness of the spirit by 62% i.e. from 8 to 3 on a 10 point sensory scale, where 1 is least and 10 is the highest perceived intensity of a given attribute by a panelist. However, due to reduced harshness, other desired sensory attributes are unmasked and increased. For example, the sweetness is increased by 66% i.e. from 3 to 5, fruity note is increased by 66% i.e. from 3 to 5, floral note is increased by 50% i.e. from 4 to 6 and mellow note is increased by three times i.e. from 2 to 6 in a fresh malt spirit.

The sulphur compounds are generally present at ppb levels in a fresh malt spirit and are below detection limits, e.g. as analyzed by gas chromatography coupled with a flame ionization detector (GC-FID) analysis. Hence, to illustrate the reduction of sulphur compounds by physico-chemical conditions, such sulphur compounds such as thiophene, S-methyl thioacetate, dimethyl di-sulphide, 2-Methyl thiophene, 2,5-Dimethyl thiophene, Dimethyl tri-sulphide are spiked in fresh malt spirit (50 ppm each) in quantifying level of GC-FID method are exposed to physico-chemical reaction conditions for two weeks at 50° C. and 1.5 kg/cm2 oxygen pressure. The results indicate reduction in sulphur compounds up to 70% in two weeks' time without affecting the essential congeners in the spirit, such as esters, acids and aldehydes. Most of these compounds are completely reduced in four weeks.

The method involves the step of maintaining physico-chemical parameters such as temperature and oxygen gas pressure with a specified time, which results in reduction of harshness of the fresh malt spirit.

### BRIEF DESCRIPTION OF DRAWINGS

FIG. 1 illustrates an apparatus to treat a spirit to reduce its harshness, according to the invention;

FIG. 2 illustrates method steps of the invention for removal of harshness of the fresh malt spirit by using physico-chemical conditions;

FIG. 3 illustrates the effect of the physico-chemical treatment on the sensorial attributes of the fresh malt spirit;

FIG. 4 illustrates the reduction in the sulphur compounds by physico-chemical conditions.

### DETAILED DESCRIPTION OF THE INVENTION

Reference will now be made in detail to the description of the present subject matter, one or more examples of which are shown in figures. Each embodiment is provided to explain the subject matter and is not necessarily an essential limitation. These embodiments are described in sufficient detail to enable a person skilled in the art to practice the invention, and it is to be understood that other embodiments may be utilized, and that logical, physical, and other changes may be made within the scope of the embodiments. The following detailed description is, therefore, not be taken as limiting the scope of the invention, but instead the invention is to be defined by the appended claims.

Terms for components used herein should be given a broad interpretation that also encompasses equivalent functions and features. In some cases, several alternative terms (synonyms) for structural features have been provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Any directional terms such as “vertical”, “horizontal”, “up”, “down”, “upper” and “lower” may be used for convenience of explanation, usually with reference to the illustrations, and are not intended to be ultimately limiting if an equivalent function can be achieved with an alternative dimension and/or direction.

The description herein refers to embodiments with particular combinations of features, however, it is envisaged that further combinations and cross-combinations of compatible features between embodiments will be possible. Indeed, isolated features may function independently as an invention from other features and not necessarily require implementation as a complete combination to have advantages over prior art.

In order to more clearly and concisely describe the subject matter of the claimed invention, the following definitions are provided for specific terms, which are used in the following written description.

The term “oxidation”, refers to chemical combination of a substance with oxygen or a reaction in which electron is donated as context requires.

The term “congeners”, refers to the impurities that are produced during fermentation of alcoholic beverages, which are responsible for taste and aroma of the alcohol, as the context requires.

The term “fresh spirit” or “fresh malt spirit”, refers to spirit e.g. obtained by mashing of malt or equivalent raw material followed by lautering, fermentation and distillation before maturation in contact with wood. It can also be termed as new make spirit. However, it is noteworthy that a spirit may be treated according to the invention at any appropriate stage of production. For example, a spirit may be removed from a wooden barrel for transfer to another and be treated during the transition or at any other time to assist in accelerated ageing of the spirit before human consumption.

The term “gas chromatography”, refers to chromatography employing a gas as a mobile phase, as the context requires.

The term “flame ionization detector”, refers to a detection system coupled to gas chromatography that measures the concentration of organic compounds in a gas stream, as the context requires.

The term “gas chromatography mass spectrometry”, refers to a mass spectrometric detection system coupled to gas chromatography that measures and chemically characterizes organic compounds in a gaseous mobile phase, as the context requires.

The invention discloses an apparatus for reduction of harshness, e. g. from fresh malt spirit, by controlling/monitoring physico-chemical conditions. The invention also relates to a method for reduction of harshness from spirit. The method involves reduction of harsh taste and sensorial improvement of attributes such as sweet, fruity, floral and mellow notes in fresh malt spirit using a specific temperature, pressure and time.

According to the invention, the harshness of a distilled spirit is removed by eliminating the sulphur compounds using oxidative reactions. The sulphur compounds present in the fresh spirit are susceptible to oxidation under strong oxidizing conditions. In this invention, the harshness of the spirit is removed by using the physical parameters such as temperature, oxygen gas pressure and time.

The invention discloses a simple, rapid and selective method for removal of harshness and improvement of sensorial attributes, which involves treatment of a spirit at any stage of production with specified temperature, oxygen gas pressure and time. A spirit treated by the invention is typically transferred to wooden casks for maturation, that can be for a relatively reduced time.

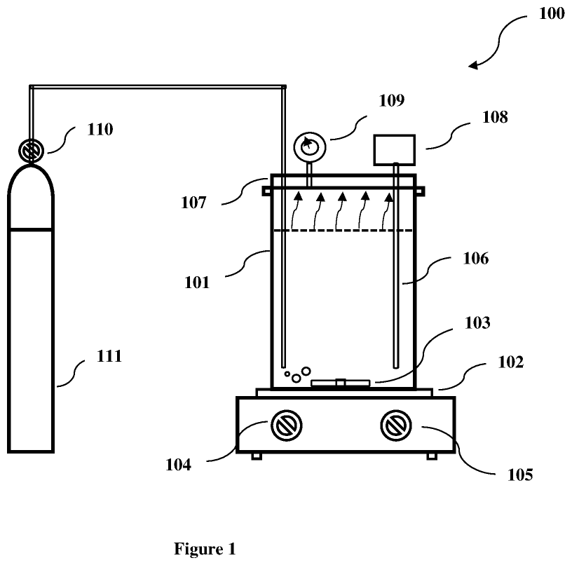

FIG. 1 illustrates an apparatus to treat fresh malt spirit to reduce its harshness. The illustrated apparatus 100 comprises a reaction vessel 101, a hot plate 102, a magnetic stirrer 103, a magnetic stirrer controller 104, a temperature controller 105, a temperature probe 106, an air tight lid 107, a temperature display 108, a pressure gauge 109, an oxygen gas regulator 110 and an oxygen gas cylinder 111. However, it will be apparent to those skilled in the art that alternative/equivalently functioning components may be employed. For example, a suitable stirrer may be any paddle turning about a rotational axis or equivalent means for agitating contents and causing even temperature distribution. Hot plate 102 may be any suitable heating element/means configured to raise temperature within the vessel 101.

The exemplified embodiment suggests use of oxygen gas at concentrations greater than normal atmospheric conditions, however, it is envisaged that air (at about 21% oxygen) may be used as the gas introduced to the system, albeit with a longer necessary reaction time for oxidation to achieve an equivalent result.

In one embodiment the reaction vessel 101 carries fresh malt spirit, and is vertically placed on the hot plate 102. The reaction vessel 101 is equipped with the magnetic stirrer 103 to continuously stir the fresh malt spirit and is controlled by the magnetic stirrer control knob 104 to regulate the speed of the magnetic stirrer 103. The temperature control knob 105 enables adjustment to a required temperature. Continuous stirring allows uniform heat distribution during heating in the reaction vessel 101.

The reaction vessel 101 comprises the airtight lid 107 at its top end, distant from hotplate 102, to open and close the reaction vessel 101. The temperature display 108 is located on the right-side top position to display the temperature sensed by the probe 106 that is placed inside the reaction vessel 101. The pressure gauge 109 is placed on the left side top position to monitor pressure inside reaction vessel 101.

The reaction vessel 101 is connected to the oxygen gas cylinder 111 for introducing oxygen gas and the required pressure is achieved and maintained via the oxygen gas regulator valve 110.

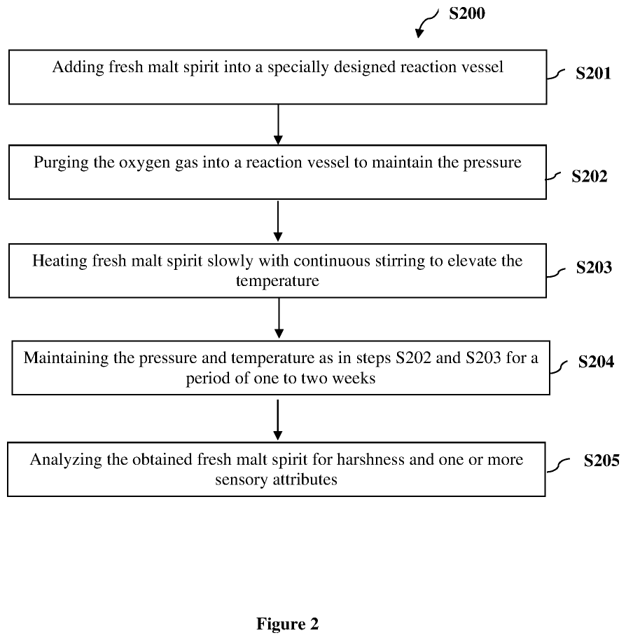

FIG. 2 illustrates a method of removal of harshness taste in a spirit (whether a fresh/new malt spirit or otherwise) by controlling physico-chemical conditions. The exemplified method refers to fresh malt spirit and a high concentration oxygen gas source.

The method S200 starts with the step S201 of adding spirit into a reaction vessel. The physical parameters of the reaction vessel are maintained at standardized temperature and pressure. At step S202, gas is introduced into the reaction vessel to maintain the pressure in a range between 0.3 kg/cm2 to 2.0 kg/cm2. In the illustrated form, the gas is specifically bubbled from the bottom so that, if pure oxygen (>99%) is used, it can displace the air and improve the concentration of dissolved oxygen in the spirit. In the process, the air accumulated in the head space is expelled and completely replaced by the oxygen gas being purged. At step S203, the spirit is heated slowly with continuous stirring to elevate the temperature to a range of approximately 30° C. to 50° C. At step S204, the pressure and temperature are maintained as in step S202 and S203 for a period of, e.g., one to four weeks. Finally, at step S205, the spirit is analyzed for harshness and sensory attributes and compared with an untreated spirit (e. g. a fresh malt spirit).

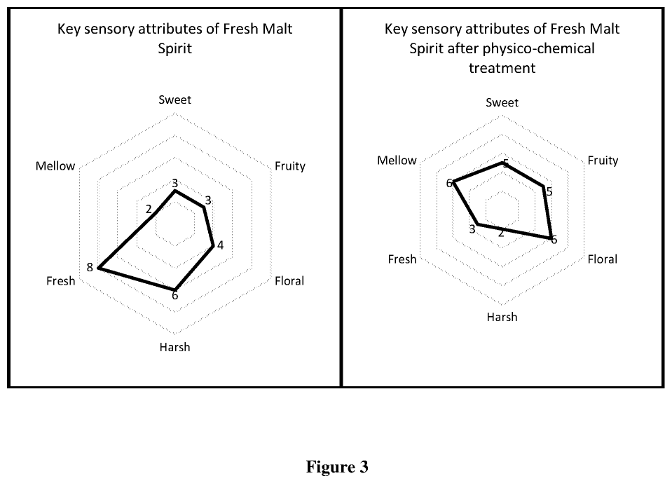

FIG. 3 illustrates the effect of the physico-chemical treatment method on the sensorial attributes of the spirit. The sensorial attributes determine the perceived quality, which alters with the age of the spirit. As shown in FIG. 3, the profile of the sensory attributes of a fresh malt spirit by an experienced in-house sensory panel shows improvement after physico-chemical treatment according to the invention. The sensory profile as seen in FIG. 3 indicates that the method of physico-chemical treatment of the invention results in reduction of harshness by 67%, i.e. from 6 to 2 and reduction in freshness by 62% i.e. from 8 to 3. In addition, other sensory attributes such as the sweetness is increased by 66%, i.e. from 3 to 5, fruity notes are increased by 66%, i.e. from 3 to 5, floral notes are increased by 50%, i.e. from 4 to 6, and mellow notes are increased by 3 times, i.e. from 2 to 6 in fresh malt spirit.

When analysed by GC-FID chromatogram, a reduction in spiked sulphur compounds is observed by the physico-chemical conditions of the invention. The sulphur compounds such as thiophene, S-methyl thioacetate, dimethyl di-sulphide, 2-methyl thiophene, 2,5-dimethyl thiophene and dimethyl tri-sulphide are spiked in fresh malt spirit (50 ppm each) in quantifying level of GC-FID method and exposed to physico-chemical reaction conditions for 2 weeks at 50° C. and 1.5 kg/cm2 oxygen pressure. The retention time of thiophene is 6.5 min, S-methyl thioacetate is 6.9 min, dimethyl di-sulphide is 7.3 min, 2-methyl thiophene is 7.6 min, 2,5-dimethyl thiophene is 8.6 min and dimethyl tri-sulphide is 11.8 mins. The results indicate that the sulphur compounds are selectively reduced without affecting the other desired distillery congeners such as, esters, fusel alcohols etc.

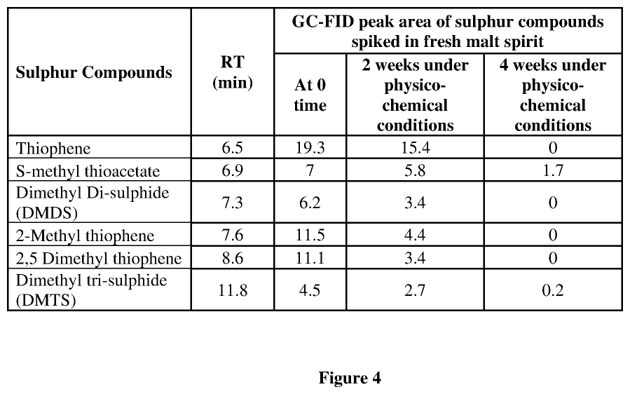

FIG. 4 tabulates relative reduction in sulphur compounds achieved by the invention. It will be apparent that sulphur compounds such as thiophene, S-methyl thioacetate, dimethyl di-sulphide, 2-methyl thiophene, 2,5-dimethyl thiophene and dimethyl tri-sulphide are reduced up to 70% in two weeks, without affecting the essential congeners in fresh malt spirit such as esters, acids and aldehydes. Furthermore, most of sulphur compounds are completely reduced in four weeks.

Having described in this invention in general terms, a further understanding can be obtained by reference to certain specific examples, which are provided herein for purposes of illustration only and are not intended to be limiting unless otherwise specified.

In addition to the reduction of harshness, the physico-chemical treatment of the fresh malt spirit also results in improvements of other sensory attributes, thus improving the quality of the fresh malt spirit. The invention discloses the effect of physico-chemical treatment on fresh malt spirit on major congeners such as esters, higher alcohols, aldehydes and acids present in fresh malt spirit. The effect of physico-chemical treatment of the fresh malt spirit was analyzed using gas chromatography (GC) coupled with flame ionisation detector (FID) and gas chromatography coupled with mass spectrometry (GC-MS). The results indicated that esters such as ethyl acetate, ethyl formate, ethyl caproate, ethyl caprylate, ethyl caprate, ethyl laurate, isoamyl acetate, phenethyl acetate etc. and higher alcohols such as n-propanol, n-butanol, isobutanol, isoamyl alcohol, phenethyl alcohol, etc. are not affected by physico-chemical treatment. Also, the GC-MS analysis, indicated that the sulphur compounds after the physico-chemical treatment showed partial to complete reduction in their response without any additional peaks. No additional peaks in GC-MS analysis indicated that the sulphur compounds were not transformed to other chemical form during the treatment but completely oxidized into oxide gases thereby escaped from the fresh malt spirit.

Acetaldehyde level was slightly increased during the physico-chemical treatment due to slow oxidation of ethyl alcohol, which is a major component of the fresh malt spirit. However, the non-significant increase in acetaldehyde level did not impart any sensorial change in the fresh malt spirit. Further, the physico-chemical treatment did not alter the levels of furfural and acetal.

Similarly, the physico-chemical treatment did not alter the levels of acids such as acetic acid, butyric acid, caproic acid etc. as analyzed by GC-FID.

The sulphur compounds present in the fresh malt spirit are at parts-per-billion (ppb) levels and are beyond the detection limit as analyzed by gas chromatography-flame ionization detector and gas chromatography mass spectrometry. The reduction/absence of sulphur compounds is attributed to the oxidation reaction induced by physico-chemical treatment according to the invention.

Physico-chemical treatment with an optimum temperature and oxygen-containing gas pressure results in oxidation of the sulphur compounds without affecting the major congeners of the fresh malt spirit. This is evident by the reduction/absence of sulphur compounds during GC analysis.

In summary, the invention relates to an apparatus and a method for reduction of perceived harshness taste in a spirit, to improve sensorial quality. The method is simple to implement and relatively rapid (compared to multi-year ageing by traditional means). Particularly, the method entails the steps of: providing spirit to a reaction vessel; introducing an oxygen-containing gas/mixture into the reaction vessel to maintain a predetermined pressure; heating the spirit to elevate the temperature to a predetermined temperature; and maintaining the predetermined pressure and temperature for a period, e.g. a predetermined period of one to four weeks.

The duration of treatment may be determined by the concentration of the oxygen gas source.

The method of the invention does not involve use of any external chemical compounds and allows selective removal of sulphur compounds that contributes to the harshness of the spirit through oxidation. Ultimately the invention is useful for reducing overall maturation time without loss in the quality of matured malt spirit that is bottled for human consumption. The method also results in improvement of sweetness, fruity, floral notes and mellow character compared to a freshly distilled spirit by unmasking these attributes from sulphur compounds.

The method involves controlling the physical parameters of temperature and oxygen-containing gas pressure for a specified time, which results in reduction of harshness of the spirit. The method, and apparatus configured to implement the method, reduces the overall maturation time of a spirit product which ordinarily involves several months to years in warm climatic conditions.

1. A method for improving taste characteristics of a spirit, comprising the steps of:
a. providing spirit to a reaction vessel;
b. introducing an oxygen-containing gas into the reaction vessel to maintain a predetermined pressure;
c. heating the spirit to elevate the temperature to a predetermined temperature; and
d. maintaining the predetermined pressure and temperature for a period

2. The method of claim 1, wherein the spirit is stirred during heating.

3. The method of claim 1, wherein the period is one to four weeks.

4. The method of claim 1, wherein the predetermined pressure is in the range 0.3 to 2.0 kg/cm2.

5. The method of claim 4, wherein the predetermined pressure is 0.5 kg/cm2.

6. The method of claim 1, wherein the predetermined temperature is in the range 30° C. to 50° C.

7. The method of claim 6, wherein the predetermined temperature is 38° C.

8. The method of claim 1, wherein the temperature is elevated to the predetermined temperature over 1-3 hours.

9. The method of claim 1, including a step of analyzing the spirit for harshness and one or more sensory attributes.

10. The method of claim 1, wherein the oxygen-containing gas is bubbled through spirit in the reaction vessel.

11. The method of claim 1, wherein the oxygen-containing gas concentration is 21-100% oxygen.

12. The method of claim 1, wherein the oxygen-containing gas concentration is 40-100% oxygen.

13. The method of claim 9, wherein said harshness of the spirit is required to be reduced by at least 60%, i.e. from 6 to 2; and/or freshness is required to be reduced by at least 60%, i.e. from 8 to 3, to terminate the period.

14. The method of claim 1, wherein sweetness of the spirit is enhanced by at least 40% by conclusion of the period.

15. The method of claim 1, wherein fruity notes of the spirit are enhanced by at least 40% by conclusion of the period.

16. The method of claim 1, wherein floral notes of the spirit are enhanced by at least 33% by conclusion of the period.

17. The method of claim 1, wherein mellow notes of the spirit are enhanced by at least three times by conclusion of the period.

18. An apparatus comprising:
a reaction vessel to hold a volume of spirit;
a heating, means configured for heating the spirit within the reaction vessel; an agitation means configured for stirring the spirit during heating for uniform heat distribution;
an inlet, for connection to an oxygen-containing gas source, for introducing gas to the reaction vessel;
a controller configured for controlling the heating means and/or inlet in execution of the method of claim 1.
